(19) United States
(12) Patent Application Publication
(10) Pub. No.: US 2016/0178220 A1
(43) Pub. Date: Jun. 23, 2016

(54) Building Heating Installation and Methodology

(71) Applicant: Mark Edwin BENSON, Buckingham, Buckinghamshire (GB)

(72) Inventor: Mark Edwin Benson, Buckingham (GB)

(21) Appl. No.: 14/778,153

(22) PCT Filed: Mar. 12, 2014
(86) PCT No.: PCT/GB2014/050725

§ 371 Date: Sep. 18, 2015

(30) Foreign Application Priority Data
Mar. 19, 2013 (GB) 1305079.4
Aug. 4, 2013 (GB) 1314225.2
Mar. 5, 2014 (GB) 1403866.5

(51) Int. Cl. F24D 19/10; F24D 7/00; C09K 5/20; F24D 3/02

(52) U.S. Cl. CPC F24D 19/1009; F24D 3/02; F24D 7/00; C09K 5/20

(57) ABSTRACT

A heating installation for a building comprises at least one source of hot water; a plurality of heat emitter means operable by passage of a heated fluid there through; and control means for the heating installation, provided with at least two temperature sensor means, wherein the or each source of hot water is operatively connected to heat exchanger means, the heat emitter means are operatively connected by at least one heat emitter circuit to said heat exchanger means, and said heat emitter means and heat emitter circuit contain an operating fluid having a freezing point below 0° C. This, together with the circuitry indicated in FIGS. 1 and 2 the components and control as specified and claimed enables room temperature to be held as low as +7° C. during unoccupied hours and with the external frost stats set as low as 2° C., a saving of energy is achieved. The heating installation can operate or be held off at temperatures above or below 0° C. This form of heating system can be applied to existing or new buildings

### FIELD OF THE INVENTION

The present invention relates to equipment for heating a building. More particularly but not exclusively, it relates to a heating installation for commercial or domestic premises that is operable with significant energy savings relative to conventional systems.

### BACKGROUND

It is common practice to turn off central heating systems in premises such as office buildings when the premises will be unoccupied (i.e. in most cases, overnight and at weekends). Turning off the central heating system can, for example, be linked to activation of a security system, or may be controlled by a suitably programmed timer. However, it is important that “wet rooms” (those having water supplies and/or drainage) do not become so cold that freezing water damages pipes. Similarly, hot water heating systems supplying radiators should not be allowed to freeze.

At present, it is customary to provide control equipment for a commercial heating system linked to one or more strategically located temperature sensors. If the ambient temperature falls below a preset value, typically 3° C., it is presumed that there is a risk of frost, and the boilers of the central heating system are fired up to activate the central heating system and prevent it freezing. This can lead to significant energy consumption, particularly in the UK and Northern/Central Europe where freezing temperatures often coincide with prolonged closure of commercial premises, for example between Christmas Eve and 2^{nd} January. It would therefore be beneficial to provide a heating installation for a building or part of a building that is protected against freezing but which has a lower energy consumption than existing installations.

It is hence an objective of the present invention to provide a heating installation that allows a building to be maintained at a lower target temperature while obviating the risk of localised freezing in remote parts of the building.

### SUMMARY OF THE INVENTION

According to a first aspect of the present invention, there is provided a heating installation for a building comprising at least one source of hot water, a plurality of heat emitter means operable by passage of a heated fluid therethrough, and control means for the heating installation, provided with at least one temperature sensor means, wherein the or each source of hot water is operatively connected to heat exchanger means, the heat emitter means are operatively connected by at least one heat emitter circuit to said heat exchanger means, and said heat emitter means and heat emitter circuit contain an operating fluid having a freezing point below 0° C.

Preferably, said operating fluid has a freezing point below −5° C.

Advantageously, said operating fluid has a freezing point of −10° C. or lower.

Preferably, said operating fluid comprises water and an additive that reduces the freezing point of water.

Said additive may comprise a metal salt or other proprietary solute such as Alphi produced by Fernox.

Said metal salt may comprise sodium chloride as brine.

Alternatively, said additive may comprise an organic compound, such as corn oil (i.e. Sorbitol or equivalent).

The operating fluid may further comprise an anticorrosive agent and/or additives adapted to oppose build-up of deposits within the heat emitter circuit.

Preferably said heat emitter circuit or circuits comprises piping means comprising a corrosion-resistant material such as Vulcathene, plastic or equivalent material.

Advantageously, said piping means comprises a corrosion-resistant metal.

Said piping means may comprise steel, optionally a stainless steel.

Preferably, the or each heat emitter circuit is provided with circulating pump means, wherein fluid contact components of said pump comprise a corrosion-resistant material, advantageously a corrosion-resistant metal, such as a stainless steel.

A portion of the heat-exchanger means through which the operating fluid passes may also comprise a corrosion-resistant material, such as a stainless steel.

The source of hot water preferably comprises conventional water boiler means.

The source of hot water may be connected to the heat exchanger means by conventional piping means, such as copper piping.

Preferably, the control means is programmed to operate the heating installation when its temperature sensor means indicates a ambient temperature of −2° C. or lower.

Advantageously, the control means is programmed to operate the heating installation when its temperature sensor means indicates an ambient temperature of +7° C. or lower.

The heating installation may be provided with fluid storage means, into which operating fluid from the or each heat emitter circuit may be drained.

The heating installation may be provided with fluid header tank means, from which the heat emitter circuit may be topped-up and/or filled.

The or each heat emitter circuit may be provided with means to introduce a scouring agent to remove deposits from an interior of the heat emitter circuit, heat emitter means and associated pump means.

The or each heat emitter circuit may be provided with means to monitor a concentration present of an additive to reduce the freezing point of water.

The or each heat emitter circuit may then be provided with means to introduce said additive and optionally water, so as to adjust the concentration of the additive to a predetermined preferred concentration.

Additionally, where the heating system is a commercial system, the pipes are generally of mild steel rather than copper, and so are more prone to corrosion from brine. A second additive may be applied to provide a thin protective coating to the mild steel pipes, thereby permitting the present method to be used on commercial heating systems as well as domestic or residential heating systems.

According to a second aspect of the present invention, there is provided a method of heating a building, comprising the steps of providing a heating installation as described in the first aspect above and causing it to operate normally when an ambient external temperature falls to −2° C. or below.

Preferably, the method comprises causing the heating installation to operate when idle or off when the ambient external temperature falls to minus −7° C. or below.

This system and circuitry allows the room temperature is to be set as low as +7° C. with the external frost thermostat(s) able to be at −2° C. or below during unoccupied hours, and thereby achieve energy savings.

The invention includes a heating installation for a building comprising at least one source of hot water; a plurality of heat emitter means operable by passage of a heated fluid there through; and control means for the heating installation, provided with at least two temperature sensor means, wherein the or each source of hot water is operatively connected to heat exchanger means, the heat emitter means are operatively connected by at least one heat emitter circuit to said heat exchanger means, and said heat emitter means and heat emitter circuit contain an operating fluid having a freezing point below 0° C. This, together with the circuitry indicated in FIGS. 1 and 2 the components and control as specified and claimed enables room temperature is to be held as low as +7° C. during unoccupied hours and with the external frost stats able to be set at −2° C., or below and thereby an saving of energy is achieved.

The heating installation can operate at temperatures above 0° C. and not freeze when idle between 0° C. and at least −5° C.

Other aspects are as set out in the claims herein.

### BRIEF DESCRIPTION OF THE DRAWINGS

For a better understanding and to show how the same may be carried into effect, an embodiment of the present invention will now be more particularly described by way of example and with reference to the accompanying drawings in which:

FIG. 1 is a schematic representation of the main features of a domestic/residential or retail heating installation embodying the present invention; and

FIG. 2 is a schematic representation of the main features of a commercial/industrial heating installation embodying the present invention.

### DETAILED DESCRIPTION OF THE EMBODIMENTS

In this specification, “heat emitter means”, means any form of heater in any circuit used to provide heat to a building, such as air conditioning units, heater batteries, variable air volume (VAV), ceiling units, radiant panels, door curtains, and radiators.

Heat emitter circuit means a circuit including one or more heat emitters.

Whilst an example is provided below where the heat emitter means are radiators, the heat emitter means are not restricted to radiators.

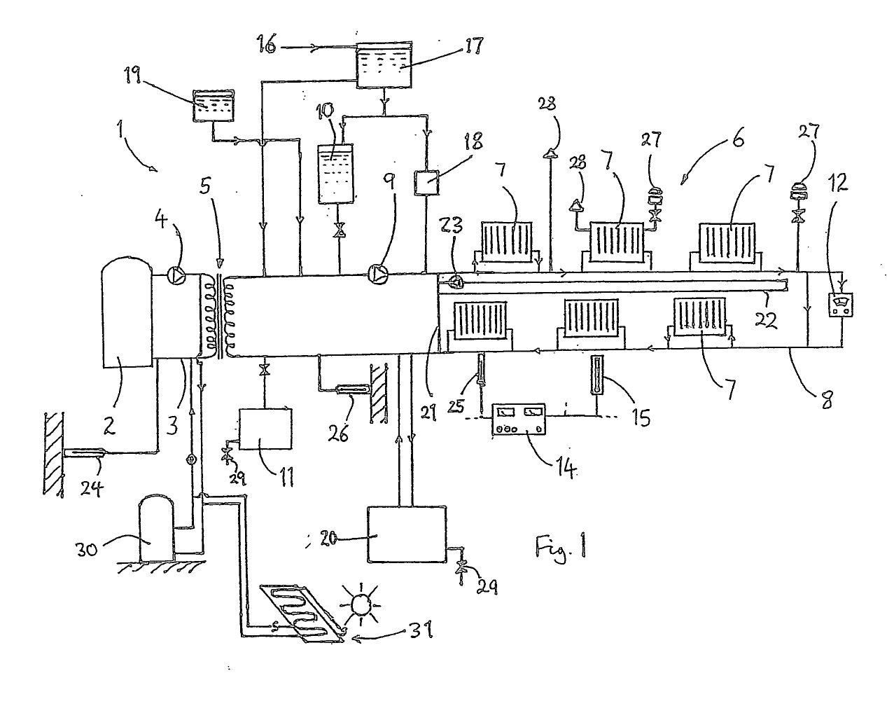

Referring now to FIG. 1, a simpler heating installation 1 suitable for domestic/residential or retail premises comprises a conventional hot water boiler 2, operatively connected by a primary heating water piping circuit 3 to a heat-exchanger 5. A primary heating water pump 4 drives hot water from the boiler 2 through the primary heating water piping circuit 3 and the heat exchanger 5 back to the boiler 2. The boiler 2 may be of carbon or stainless steel; the heat exchanger 5 is preferably stainless steel.

A radiator circuit 6 is operatively connected to the hot water boiler 2 and primary heating circuit 3 by the heat exchanger 5 alone. The radiator circuit 6 contains a plurality of radiator units 7 and/or radiant panels, linked by stainless steel radiator piping 8. The radiator circuit 6 also contains a radiator circuit pump 9, the operative components of which are also made from stainless steel. Pumps 9 of this type have been developed for pumping liquid sewage and are readily available. The radiator units 7 and/or radiant panels may also be made from stainless steel, or alternatively may be provided with a corrosion-resistant lining.

The main difference between the radiator circuit 6 and a conventional radiator circuit is that the radiator circuit 6 is filled with brine, a concentrated solution of common salt, sodium chloride, at a sufficient concentration that the freezing point of the water in which the salt is dissolved is reduced from approximately 0° C. to approximately −10° C. The brine may also include an anti-corrosive additive, to help the materials of the radiator circuit resist being corroded by hot brine. With the correct anti-corrosive additive, it may be possible for the radiator piping 8 to comprise mild steel. It may further include known additives to resist the formation or hard settlement of deposits within the radiator circuit 6.

The radiator circuit pump 9 drives the brine around the radiator circuit 6, through the radiator units 7 and through the heat-exchanger 5, in which the brine absorbs heat from the hot water in the other side of the heat exchanger 5, to bring the brine up to a working temperature.

A radiator circuit brine tank 10 is connected through a controllable valve to the radiator circuit 6. This allows the level of brine within the radiator circuit 6 to be replenished, should it fall, as well as refilling the radiator circuit 6 if it has had to be drained down (see below). A brine injection unit may also be provided.

A radiator circuit dump tank 11 is also operatively connected through a controllable valve to the radiator circuit 6. The radiator circuit dump tank 11 is so located that the contents of the radiator circuit 6 may conveniently be run off into it, ideally under gravity. This may be necessary to swill deposited material out of the radiator circuit 6, or may be desirable if the building is not to be used for some time and the heating system 1 is to be mothballed. It may well be necessary to scour an interior of the radiator circuit 6 periodically, to shift deposits that might restrict or block passage through the radiator piping 8 and radiator units 7, just as for conventional central heating systems. (See below for details).

This particular example of the radiator circuit 6 is also provided with a brine monitoring unit 12, which checks the salt concentration in the brine to ensure that its freezing point remains below −10° C. A straightforward conductivity meter may suffice, for example. This monitoring may be continuous, as shown, or periodic. A reserve tank of concentrated brine may be provided, but it should be sufficient for dosage from the brine tank 10 to be controlled, in line with concentration readings from the brine monitoring unit 12, so as to add sufficient concentrated brine to bring the salt concentration in the radiator circuit 6 up to the desired range. Similarly, if it is envisaged that the salt concentration in the brine might become too high (maybe risking salt crystallising out and causing blockages), water may be added from a water-make-up tank 17, controlled in line with concentration readings from the brine monitoring unit 12 to deliver water (or low concentration brine) into the radiator circuit 6 to reduce the salt concentration in the brine to the desired range.

A control unit 14 is provided to control the residential/retail heating installation 1, connected to a plurality of temperature sensors 15 (these are represented as a thermometer in the Figures for clarity, but in practice one may use any existing form of temperature sensor capable of returning a signal, representing a current ambient temperature, to the control unit 14). The temperature sensors 15 may be situated outside the building being heated, or in selected rooms within the building that would be particularly sensitive or liable to freezing, or in each room, as desired. The control unit 14 is operatively connected to the boiler 2, the primary heating water pump 4 and the radiator circuit pump 9 (the relevant wiring is omitted from the Figures, for clarity).

In a full residential/retail heating installation 1, further features will be present, as shown in FIG. 1. A conventional cold water supply pipe 16 (boosted or via an open cold water supply tank) fills an optional water make-up tank or water feed tank 17. Water from tank 17 may be used to make up brine in the brine tank 10. It may also be used to flush into the radiator circuit 6 solvents and inhibitors to resist the build-up of detritus within the radiator circuit 6 and radiator panels 7. For this, an optional solvent/inhibitor tank 18 and injector unit may be located downstream of the water make-up tank 17. The radiator circuit 6 may also be provided with a dedicated scouring agent tank 19, from which a charge of scouring agent may be pushed through the radiator circuit 6 to scour out deposits that may have formed within the radiator circuit 6, particularly within the radiator panels 7, inhibiting circulation.

A flushing tank 20 is also provided in this particular example, providing additional volume in the radiator circuit 6 to allow materials to be flushed through the radiator circuit 6 and optionally dumped via a lock-shield valve 29. For safety's sake, a lock-shield valve 29 is also fitted to the dump tank 11.

Where the residential/retail heating installation 1 is to comprise two or more secondary heating circuits, not merely a single radiator circuit 6, a secondary header 21 is incorporated, allowing brine to pass through not only the radiator circuit 6 but also a secondary heating circuit 22 (shown here only schematically) with its own secondary circuit pump 23. (In this case, it may well be necessary to relocate the radiator circuit pump 9 from the position shown in FIG. 1 to a point downstream of the secondary header 21, so that it acts only on the radiator circuit 6 proper).

As well as the room temperature sensor 15, it will usually be preferable to add a boiler frost stat 24, a radiator circuit/secondary circuit low temperature stat 25, and a secondary header frost stat 26, to ensure that excessively low temperatures in these parts of the residential/retail heating installation 1 can be spotted and corrected. (Note: the term “stat” is used herein for thermostatic sensors, a “frost stat” being employed to warn when an exterior of the building, a zone of an interior of the building or a particular portion of the pipework is at or near the dangerous temperature of 0° C.).

As good practice, the radiator circuit 6 and at least one radiator panel 7 should be fitted with manual or controlled air admittance valve sets 27, and the radiator circuit 6 and radiator panels 7 should be fitted with automatic air vents 28 to help bleed the system.

Ideally, as in the example shown, a conventional hot water system 30 could be incorporated into the residential/retail heating installation 1 (as long as the hot water boiler is not a Combi system). Thus, hot water that is not being supplied to taps, etc, can be added to the primary heating water piping circuit 3. Additionally, where a solar panel heat source 31 has been installed, heated water therefrom could also usefully be added to the primary heating water piping circuit 3, as shown.

During periods when the building is occupied, the residential/retail heating installation 1 can be operated substantially as a conventional central heating system. However, it has an alternative operating mode, to be employed when the building is unoccupied (this alternative mode may be triggered by activation of a building security/alarm system, or by a tinier, or even manually).

In the alternative mode, embodying the present invention, the control unit 14 monitors the temperature readings from the temperature sensors 15, 24, 25, 26. Since the brine in the radiator circuit 6 will not freeze below −10° C., the control unit 14 is set at a threshold temperature of +7° C. When a temperature sensor 15 indicates that the ambient temperature has fallen to minus −7° C., the control unit 14 fires up the boiler 2, then operates the primary heating water pump 4 to deliver hot water to the heat exchanger 5, and operates the radiator circuit pump 9 to deliver brine heated in the heat exchanger 5 to the radiator units 7. The radiator piping 8 and radiator units 7 should thus never cool down to the point at which the brine freezes and there is a risk of burst pipes and sprung joints. For any part of the premises requiring to be kept at a higher temperature than plus +7° C. (for example, kitchens and washrooms), a separate conventional radiator circuit could be provided, or an independently operable offshoot of the heating installation may be provided, set to operate at the conventional +3° C. threshold to avoid that part of the premises ever reaching 0° C.

Even if part of the premises must be heated conventionally in this way, the savings in energy resulting from being able to leave the heating off, down to a temperature possibly 10° C. lower than for existing systems, will lead to major cost savings. It is currently estimated that an immediate reduction would be achieved of 6-8% of the total energy budget for heating during unoccupied hours.

In some buildings even where the measured room temperature inside the building is above freezing point, there can still occur condensation within walls, leading to damp. Interstitial condensation or compounding may occur within walls due to the presence of other adjacent colder walls or ground works. There are known products which can be applied particularly to internal walls which reduce the risk of presentation of condensate in the form of damp or staining. In the present embodiments, the outside temperature below which the heating system will turn on can be selected so as to avoid the freezing of interstitial condensation within walls.

Research has identified products such as Wallrock® (Erfurt Mav) thermal wall liner or Thermodry® paint additive that can assist in eliminating break out of condensation on the inside of external walls. These products also assist in increasing the wall surface temperature by up to 4° C.

By adding wall liners or paint additive, the condensation and damp can be restricted together with achieving an improved wall temperature gradient.

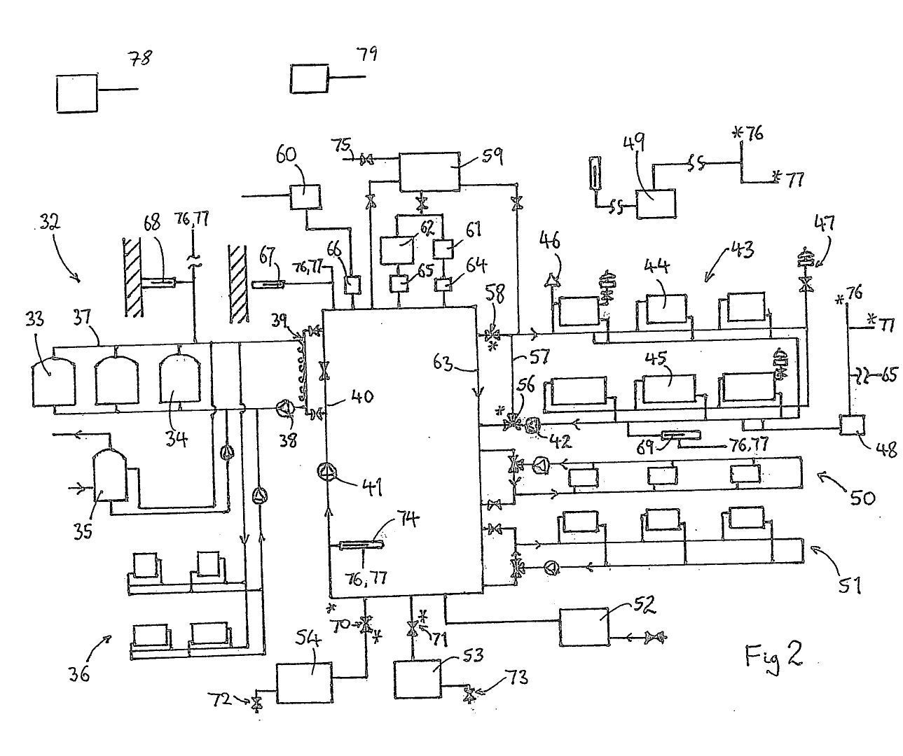

FIG. 2 shows a more complex commercial/industrial heating installation 32, suitable for heating an office block, department store, factory, workshop or the like. Such heating installations 32 would typically use several conventional hot water boilers 33 in parallel, in this case also being provided with a buffer vessel 34 to retain a reserve of hot water. As in the case of the residential/retail system 1, a conventional hot water cylinder 35 and associated system may also be connected to a primary heating header circuit 37, together with the hot water boilers 33 and the optional buffer vessel 34. A traditional central heating circuit 36, run from the primary heating header circuit 37, heats the “wet and hot rooms” (such as toilets, mess rooms, canteens and the like) that would always be kept above 0° C. to prevent piping to taps, etc, freezing. A primary heating circuit pump 38 maintains circulation around the primary header circuit 37.

In the case of commercial heating system, new installations can be manufactured from stainless steel components to avoid corrosion problems from the brine.

On the other hand, for existing heating systems which are generally made of mild steel pipes and components, to adapt the existing systems to use brine as a heat transfer fluid, an anticorrosive additive can be used to coat the inside of the pipe work, pumps and other components to protect against corrosion. Such an additive may comprise the product Accept® 2319 or 2320, or a like anticorrosion additive produced by Accepta Limited. The Accepta 2320 additive comprises a blended liquid formulation based on organic tannin, polymer sludge conditioners, and alkali. Alternatively, a condensate line protection additive available under the brand name Accepta® may be used or alternative products such as Chemtex brine inhibitor Protodin® CN65 and related additives of Chemtex International Inc. The purpose of the anticorrosion additive is to seal the mild steel inner surfaces of the pipe work and/or radiators of the existing commercial heating systems, sealing the pores and micro cracks by providing a penetrative and/or sealing coating between the mild steel and the heating fluid, to prevent the heating fluid corroding the heating system components. An existing mild steel radiator circuit commercial heating system may be converted by replacement of components such as water pumps, but without the need to replace the whole pipe and radiator installation, which can be protected by the anticorrosive additive.

As in the case of the residential/retail heating installation 1, the commercial heating installation 32 connects its primary heating header circuit 37 to a remainder of the heating installation 32 via a stainless steel heat exchanger 39. However, in this case, there is a more complex arrangement in which various radiator circuits and the like are separately connected to a core heat exchanger secondary heating header circuit 40, through which brine is circulated by a secondary header circuit pump 41. The heat exchanger secondary heating header circuit 40 can be isolated from the heat exchanger 39 itself if desired, for example for maintenance.

In this particular example, a variety of possible heating circuits are shown, all leading off from the heat exchanger secondary heating header circuit 40. A first secondary brine heating circuit 43, with a secondary brine heating circuit pump 42 to maintain circulation, comprises stainless steel piping, although it may be possible to use mild steel if it is suitably protected (see below).

In this secondary brine heating circuit 43, both radiant panels 44 and domestic-style radiators 45 are shown, permitting heating both near floor level and nearer a roof space. Optionally, automatic air vent control units 46 and air admittance valves 47 with associated control units may be provided on radiators 45, radiant panels 44 and/or on the secondary brine heating circuit 43 itself. A brine monitoring unit 48 is tapped into the secondary brine heating circuit 43 and monitors the concentration of brine in the circuit 43, in the same manner as the brine monitoring unit 12 on the radiator circuit 6 of the residential/retail heating 3o installation 1 (see above). If more brine is needed, local top-up tanks could be provided, but in this example a single brine tank 62 (see below) is provided to top-up the entire secondary heating header circuit 40 and all the secondary heating circuits. As another alternative, a local brine injector point 65 may be used, as illustrated.

The secondary brine heating circuit 43 is regulated on the basis of temperature data from one or more room temperature control thermostats 49 in the same room space. (Note: 76 indicates a data and/or control link to a Building Management System that inter alfa controls the commercial heating installation 32, and 77 indicates a data and/or control link to a security system for the building, for reasons explained below; any feature on FIG. 2 indicated with an asterisk* is controllable remotely by the Building Management System, although it is possible to control remotely even more valves, etc, than are shown, if desired).

A second secondary brine heating circuit 50 is connected to a plurality of individual VAVs (Variable Air Volume units), each containing a heater unit and linked to local room thermostats for individual room heating. (Ancillary features, as for the first secondary brine heating circuit 43, may optionally be provided).

A third secondary brine heating circuit 51 provides heated brine to a series of heater batteries, which would typically be used to warm air passing through air handling circuits to provide background warmth and ventilation, e.g. in larger spaces. (Again, the ancillary features shown for the first secondary brine heating circuit 43 may each optionally be fitted to this circuit 51 also).

A series of optional tanks are connected to the secondary brine heating header circuit 40, preferably towards its lower reaches. A pressurisation unit 52 is provided, to maintain working pressures in all the brine circuits 40, 43, 50, 51.

A flushing tank 53 may be provided as in this example, corresponding to the flushing tank 20 in the domestic heating installation and having the same function (see above). A remotely controlled flushing tank control valve 71* controls access to the flushing tank 53, which is also provided with a flushing tank lock-shield drain valve 73 to control dumping flushed materials from the flushing tank 53.

A dump tank 54 is provided, corresponding to the dump tank 11 in the residential/retail heating installation 1 and having the same function (see above). A remotely controlled dump tank control valve 70* controls access from the secondary brine heating header circuit 40, and a dump tank manual or auto shut-off drain valve 72 allows controlled disposal of materials dumped off into the dump tank 54.

Each of the secondary brine heating circuits 43, 50, 51 is isolatable from the secondary brine header heating circuit 40. A remotely controllable diverter valve 56* (marked on the first secondary brine heating circuit 43 only, but present on each), a secondary circuit diverting header 57 and a circuit automatic shut-off valve 58* facilitate isolation of the secondary brine heater circuits 43, 50, 51, for example for maintenance, or if the respective space to be heated is maintaining a desired temperature without requiring assistance. (The circuit automatic shut-off valve 58* is required to protect other circuits when the secondary brine heating circuit 40 in question is being by-passed).

Also connected to the core secondary brine heating header circuit 40 is an optional set of top-up and dosing tanks, similar to those in the residential/retail heating installation 1. A secondary boosted cold water supply tank 59 may be used, filled from a boosted cold water supply pipe 75, as shown, although open cold water tanks on a direct boosted cold water supply might also be feasible for some other examples.

Here, the cold water supply tank 59 feeds a brine make-up and top-up tank 62, provided with a brine injector point 65 into the secondary brine heating header circuit 40. The cold water supply tank 59 also feeds a solvent/inhibitor tank 61 provided with a solvent injector point 64, also into the secondary brine heating header circuit 40 (the function of the solvent/inhibitor tank 61 is the same as that of the solvent/inhibitor tank 18 in the residential/retail heating installation 1, above).

A scouring agent tank 60 is provided in this example, provided with a scouring agent injector point 66 into the secondary brine heating header circuit 40 (the function of this corresponding to that of the scouring agent tank 19 of the residential/retail heating installation 1, above). The use of tanks 59, 60 61 & 62 are all optional to suit the functional requirements of the various injectors.

As for the residential/retail heating installation 1, the commercial heating installation 32 is provided with a number of strategically-located frost stats and other temperature sensors, to ensure that there are no localised out-of-range temperatures in the building. Examples shown in FIG. 2 include a secondary header circuit/heat exchanger external frost stat 67; a boilers and primary header circuit frost stat 68; a secondary brine heating circuit return flow frost stat 69 (also may be fitted to the other secondary brine heating circuits); and a secondary heat exchanger header circuit flow pipe stat 74. Each of these stats has a data link 76 to the Building Management System and a data link 77 to the building's security system. (Note: the term “stat” is used as described above in respect of the residential/retail heating installation 1).

The commercial heating installation 32 as a whole is controlled and operated by the overall Building Management System, usually based in a dedicated Facilities Management Room, from which it may be continuously or periodically monitored by a human member of staff. Alternatively, it may be left unmanned, but monitored remotely via conventional telemetry. Optionally, a dedicated control subsystem might be provided for the heating installation 32, akin that provided for the residential/retail heating installation 1, in which case the data from the frost stats and other temperature data would be routed there, as well as or instead of to the Building Management System.

The systems which use motor control panels, pumps, boiler, control valves, BMS or security alarm all require the provision of a power supply 79.

The security system provides a reliable activation system for the commercial heating installation 32. The building security system will be activated as a final step when the premises are emptied and closed (e.g. in the evening or over a public holiday). Activation of the security system also signals a change in the desired temperature parameters within the building, which currently might well be held in the range of 12° C.-15° C. even when unoccupied. For example, a lower temperature threshold might be dropped from 12° C. to 8° C., and all thermostats might be reset 5° C. lower. Apart from “wet and hot rooms”, some or all of the remainder of the building may be maintained safely at a low temperature by the action of the commercial heating installation 32, operating reliably at temperatures below 0° C. if necessary.

The benefits and cost savings are at least as high as those set out for the residential/retail heating installation, above.

Component List for FIG. 1:
1. Heating installation (i.e. whole system) and optional extra circuit together with hot water service and optional solar panel circuits.
2. Conventional hot water boiler either carbon or stainless steel
3. Primary heating water piping circuit
4. Primary heating pump
5. Heat-exchanger—stainless steel (Necessary if existing boiler is not stainless steel)
6. Radiator circuit (i.e. brine system)
7. Radiators or Radiant Panels
8. Stainless steel or mild steel pipework
9. Radiator circuit pump
10. Brine tank—optional complete with brine injection unit
11. Dump tank
12. Brine monitoring unit located with item 10 or as shown
13. Optional reserve tank of concentrated brine—to suit brine monitor location(s)
14. Control unit for boiler, pumps, valves and thermostats
15. Room Temperature sensor
16. Conventional cold water supply pipe direct boosted or via open feed tank
17. Water make-up tank or feed tank (optional)
18. Solvent/inhibitor tank (optional) and injector unit
19. Scouring agent tank (optional) and injector unit
20. Flushing tank (optional)
21. Optional secondary header where two or more secondary heating circuits are employed
22. Optional secondary heating circuit number 2
23. Optional circuit number 2 heating pump
24. Boiler external frost stat
25. Secondary circuit low temperature stat
26. Optional secondary Header frost stat
27. Air admittance valve set
28. Automatic air vent
29. Lock-shield valve
30. Conventional hot water system
20. Solar panel heat source

Component List for FIG. 2:
32. Commercial heating installation
33. Conventional hot water boiler(s)
24. Optional buffer vessel system
35. H W S Cylinder traditional heating circuit
36. Wet & Hot Rooms traditional heating circuit
37. Primary Heating Header circuit
38. Primary circuit pump
39. Heat-exchanger (Stainless steel)
40. Heat exchanger secondary header heating circuit
41. Header circuit pump
42. Secondary brine heating circuit pump
43. Secondary brine heating circuit (number 1)—radiator circuit may be existing mild steel construction or optional new-build stainless steel
44. Typical Radiant Panel
45. Typical Radiator
46. Optional Automatic Air Vent Control unit
47. Air Admittance Valve & control valve
48. Brine monitoring unit—optional for each circuit and see also 65—at static injector point)
49. Room temperature control thermostat(s)
50. Secondary brine heating circuit (number 2)—likely Variable temperature—VAVs
51. Likely brine heating circuit (number 3)—constant temperature—heater batteries etc.
52. Pressurisation Unit—for all brine circuits
53. Flushing tank (Optional)
54. Dump tank
55. Secondary brine circuit number 1 heating pump
56. Diverting control valve—on each secondary circuit
57. Secondary circuit diverting header—on each secondary circuit
58. Circuit automatic shut-off valve—on each secondary circuit
59. Secondary boosted cold water supply tank (optional)
60. Scouring Agent tank (optional)
61. Solvent Inhibitor tank (optional)
62. Brine tank (optional)
63. Heat Exchanger Secondary Header—mild or stainless steel pipework
64. Solvent injector point
65. Brine injector point—including static controlling monitoring unit linked to BMS & Security
66. Scouring agent injector point
67. Secondary header (heat exchanger) circuit external frost stat
68. Boilers—primary circuit external frost stat
69. Secondary circuit(s) return flow pipe stat
70. Dump tank control valve
71. Flushing tank—(optional)—control valve
72. Dump tank manual or auto shut off drain valve
73. Flushing tank lock-shield drain valve
74. Heat exchanger secondary header—flow pipe stat
75. Boosted cold water supply pipe
76. (link to) Building Management System
77. (link to) Security system.
78. BMS Building Management System
79. MCP Motor Control Panel & Power supply system.

1-30. (canceled)

31. A heating installation for a building, comprising:
at least one source of hot water;
a primary circuit directly serving areas of the building requiring a heat supply;
a secondary circuit directly providing heat supply to a heat exchanger;
a plurality of heat emitter circuits operable by passage of a heated fluid there through;
and control means for the heating installation, the control means being provided with at least two temperature sensor means,
wherein the at least one temperature sensor means comprises at least one external temperature sensor positioned to measure outside air temperature outside of a the building in which the heating installation is located, and at least one internal room temperature sensor located internally in the building for measuring a temperature of at least one room in the building; and
at least one temperature sensor in the secondary pipework circuit providing a third layer of protection against freezing;
wherein the or each source of hot water is operatively connected to the heat exchanger by the secondary direct circuit;
a plurality of heat emitter means are operatively connected by at least one heat emitter circuit to the heat exchanger means; and
the heat emitter means and the heat emitter circuit contain an operating fluid having a freezing point below 0° C.;
wherein the control means is operable to activate the heat exchanger to transfer heat from the hot water source to the heat emitter means when an external ambient temperature of a first temperature is detected by the external temperature sensor; and,
the control means is operable to activate the heat exchanger to transfer heat from the hot water source to the heat emitter means when an internal temperature at a second temperature is detected by the internal room temperature sensor.

32. The heating installation as claimed in claim 31, wherein the control means is operable to activate the heat exchanger to transfer heat from the hot water source to the heat emitter means when an external ambient temperature of a the first temperature of −2° C. or lower is detected by the external temperature sensors.

33. The heating installation as claimed in claim 31, wherein the control means is operable to activate the heat exchanger to transfer heat from the hot water source to the heat emitter means when an internal temperature of a the second temperature of 7° C. or lower is detected by the internal room temperature sensor.

34. The heating installation as claimed in claim 31, wherein the operating fluid has a freezing point below −5° C.

35. The heating installation as claimed in claim 34, wherein the operating fluid has a freezing point of −10° C. or lower.

36. The heating installation as claimed in claim 31, wherein the operating fluid comprises water and an additive that reduces the freezing point of water.

37. The heating installation as claimed in claim 36, wherein the additive comprises an additive selected from the set:
a metal salt; or
Alphi produced by Fernox®.

38. The heating installation as claimed in claim 37, wherein the metal salt comprises sodium chloride or brine.

39. The heating installation as claimed in claim 36, wherein the additive as selected form the set:
an organic compound; corn oil; or
Sorbitol.

40. The heating installation as claimed in claim 31, wherein the operating fluid further comprises an anticorrosive agent and/or additives adapted to line the internal walls of mild steel pipes and retard corrosion especially where brine is used within the heat emitter circuits, and as selected from Accepta; or Protodin CN65.

41. The heating installation as claimed in claim 31, wherein the heat emitter circuit or circuits comprises piping means comprises a material selected from the set: mild steel; stainless steel; Vulcathene; plastic.

42. The heating installation as claimed in claim 41, wherein the piping means comprises a corrosion-resistant metal.

43. The heating installation as claimed in claim 41, wherein the piping means comprises mild steel, or stainless steel.

44. The heating installation as claimed in claim 31, wherein the or each heat emitter circuit is provided with circulating pump means, wherein fluid contact components of the pump comprise a corrosion-resistant metal.

45. The heating installation as claimed in claim 31, wherein a portion of the heat-exchanger means through which the operating fluid passes also comprises stainless steel.

46. The heating installation as claimed in claim 31, wherein the control means is programmed to operate the heating installation when its temperature sensor means indicates an external ambient temperature of −2° C. or lower.

47. The heating installation as claimed in claim 46, wherein the control means is programmed to operate the heating installation when its temperature sensor means indicates an ambient external temperature of minus −7° C. or lower thereby protecting all heating circuits

48. The heating installation as claimed in claim 31, wherein the or each heat emitter circuit is provided with means to monitor a concentration present of an additive to reduce the freezing point of water.

49. The heating installation as claimed in claim 48, wherein the or each heat emitter circuit is provided with means to introduce the additive and optionally water, so as to adjust the concentration of the additive to a predetermined preferred concentration.

50. The heating installation as claimed in claim 31, comprising a protective additive for providing a barrier between the operating fluid and the heat emitter circuit and heat emitter means.

51. The heating installation as claimed in claim 50, wherein the protective additive comprises a compound comprising a polymer sludge.

52. The heating installation as claimed in claim 50, wherein the protective additive comprises a compound comprising a tannin.

53. The heating installation as claimed in claim 50, wherein the protective additive comprises a compound comprising an alkali.

54. The heating installation as claimed in claim 50, wherein the protective additive comprises a compound which forms a thin protective layer on the internal pipes of the heat emitter circuit and on the internal surfaces of the heat emitter means.

55. The heating installation as claimed in claim 31, comprising an air admittance control means.

56. The heating installation as claimed in claim 31 comprising at least one air admittance valve and a related control valve.

57. The heating installation as claimed in claim 31, comprising a frost thermostat controlling each the secondary circuit.

58. The heating installation as claimed in claim 31 comprising a pipe thermostat in each secondary circuit.

59. The heating installation as claimed in claim 31, comprising at least one room temperature thermostat.

60. The heating installation as claimed in claim 31 further comprising a thermal wall lining selected from the set: Wallrock®; Thermodry® a thermally insulating wall liner sheet.

61. A method of heating a building, using a heating installation as claimed in claim 31, comprising:
introducing an operating fluid having a freezing point below 0° C. to the heat emitter means and the heat emitter circuit; and
causing the heating system to operate to transfer heat from the heat exchanger to the heat emitter means and heat emitter circuit only when an ambient outside temperature falls to −2° C. or below.

62. The method of heating a building as claimed in claim 61, comprising the step of causing the heating installation if idle or off to operate when the ambient outside temperature falls to 5° C. or below, and being the purpose of state of the art frost thermostats.

63. The method of heating a building as claimed in claim 61, comprising a step of causing the heating installation to operate when the ambient room temperature falls below a minimum of 7° C.

64. The method of heating a building as claimed in claim 61, such that by adding wall liners or paint additive, the condensation and damp can be restricted together with an improved wall temperature gradient.

65. The method as claimed in claim 61, comprising:
setting an external control thermostat at a temperature of as low as −2° C. during periods when the building is unoccupied;
setting a room temperature as low as +5° C. during the period when the building is unoccupied.

66. The method as claimed in claim 61, which enables an optional range of temperature settings to suit the thermal and hygroscopic footprint of the building being heated; wherein for each secondary heating circuit the temperature range comprises:
an external frost thermostat setting in the range of +2° C. to −7° C.; and
an internal room temperature thermostat setting in the range 15° C. to 5° C., optimally 7° C.
